(19) United States
(12) Patent Application Publication
(10) Pub. No.: US 2018/0370423 A1
(43) Pub. Date: Dec. 27, 2018

(54) SYSTEM AND METHOD FOR A DIRECTION INDICATOR OF A MOTOR VEHICLE

(71) Applicant: Lucas Automotive GmbH, Koblenz (DE)

(72) Inventor: Torsten Marx, Andernach (DE)

(21) Appl. No.: 16/012,929

(22) Filed: Jun. 20, 2018

(30) Foreign Application Priority Data
Jun. 27, 2017 (DE) 10 2017 006 051.7

(51) Int. Cl. B60Q 1/40

(52) U.S. Cl. CPC B60Q 1/40; B60W 30/18163; B60W 2520/10

(57) ABSTRACT

A control system for at least one direction indicator of a motor vehicle, based on environmental sensors of the own motor vehicle. The environmental sensors are adapted to detect the position of the motor vehicle on a lane of a road currently being driven on. An operating element which may be operated by the driver of the motor vehicle is provided and is adapted to be imprinted with a lane changing request by the driver of the motor vehicle for changing a lane currently being driven on. A direction indicator is provided and adapted to indicate the driver's lane changing request. A controller is further provided and is adapted to cause an indication of a lane changing request transmitted to the operating element by the direction indicator. The controller is additionally adapted to repeatedly detect the position of the motor vehicle on a lane of the road currently being driven on by means of the environmental sensors and, depending on the determination of the position of the motor vehicle, to cause the termination of the indication of the lane changing request by the direction indicator.

### BACKGROUND

There are disclosed herein a system for a direction indicator of a motor vehicle and a corresponding method. This system and the method can be used in particular to assist the driver in driver-controlled motor vehicles. Details thereof are defined in the claims; the description and the drawing also contain relevant details relating to the system and mode of operation as well as to variants of the system and of the method.

### TECHNICAL FIELD

Assistance provided to a driver of a motor vehicle by steering or driver assistance systems contributes to the comfort and to the operating safety of (motor) vehicles. Steering or driver assistance systems can assist the driver in efficiently driving the motor vehicle in traffic. Ease of operation of a motor vehicle can thereby be increased, the driving of a motor vehicle can be facilitated, and the safety of all participants in traffic can be positively influenced.

known assistance system for the driver of a motor vehicle which increases driver comfort is automation of the direction indicator (“blinker”). For example, after an operating element associated with the direction indicator has been actuated once, a fixed number of individual direction indications (“blinks”) can take place. For example, a single actuation of an operating element, in particular an operating lever, can effect 3 or 5 individual direction indications, so that a lane changing request on a multi-lane carriageway or an intention of the driver to overtake is signaled to other road users.

### Underlying Problem

In particular when a motor vehicle is travelling at comparatively high (driving) speeds, for example on multi-lane freeways, a fixed number of individual direction indications is often not sufficient to accompany the entirety of an intended or ongoing lane change. A driver's intention to change lanes is therefore not reliably signaled to other road users who notice the intended or ongoing lane change of the motor vehicle only with a delay.

### Proposed Solution

A system/a method for a direction indicator of a motor vehicle assists the driver of the motor vehicle when carrying out a lane change on a multi-lane carriageway. The direction indicator is to indicate the driver's intention to change lanes until the lane change is complete, and is then to terminate automatically.

A control system for at least one direction indicator of a motor vehicle is based on environmental sensors of the own motor vehicle. The environmental sensors are adapted to detect the position of the motor vehicle on a lane of a road currently being driven on. An operating element which may be operated by the driver of the motor vehicle is provided and is so adapted that the driver of the motor vehicle imprints/transmits therein/thereto a lane changing request for changing a lane currently being driven on. A direction indicator is provided and adapted to indicate the driver's lane changing request. A controller is further provided and adapted to cause an indication by the direction indicator of a lane changing request imprinted in the operating element. The controller is additionally adapted to repeatedly detect the position of the motor vehicle on a lane of the road currently being driven on by means of the environmental sensors and, depending on the determination of the position of the motor vehicle, to effect/cause the termination of the indication of the lane changing request by the direction indicator.

The environmental sensors of the motor vehicle can be based on radar, lidar, (daylight or infrared) camera and/or ultrasound. For example, the environmental sensors can have a camera which is suitable for determining whether a vehicle is situated wholly in a lane.

In particular, the termination of the indication of the lane changing request by the direction indicator can be effected/caused when the controller determines, by means of the environmental sensors, that a vehicle is situated wholly in a lane. In a variant, the termination of the indication of the lane changing request can be effected/caused when the vehicle is situated wholly in a lane which is different from a lane originally being driven on.

The controller is able to determine the position of the vehicle in a lane with a time delay following the transmission of the lane changing intention by the driver, so that, during a lane change which has already begun, a position of the vehicle which is not wholly situated in a lane is first determined. The indication of the lane changing intention is thus terminated only when the intended lane change is wholly complete or wholly aborted. If, despite the time delay, the controller immediately determines that the vehicle is wholly situated in a lane, then it can be assumed that the lane change, for example because of an unfavorable traffic situation, has not yet begun or is already complete. In this case, the indication of the lane changing intention can likewise be terminated by the controller.

The time delay can have a predetermined duration of, for example, up to 4 seconds.

In another embodiment, the control system comprises a steering wheel sensor which is suitable for detecting a steering movement of a steering wheel of the vehicle, or a steering movement of the driver. The controller is thereby adapted to determine the position of the vehicle in a lane, in terms of time, only once the steering movement has been initiated.

In a further development, the controller is adapted to determine the position of the vehicle in a lane only after a buffer time of, for example, up to 2 seconds following initiation of the steering movement has passed.

An advantage of the control system is that the indication of the lane changing intention of the driver of the motor vehicle is terminated only when the lane change has successfully been completed or has been wholly aborted. The indication of the lane changing intention is terminated only when the vehicle is wholly in a lane of the carriageway that is being driven on (that is to say the previous or the new) again. The lane changing intention is thus reliably signaled by the direction indicator of the motor vehicle to a further road user who is late in noticing an initiated, in particular prolonged, lane change, until the lane change is complete.

### Further Embodiments and Advantageous Further Developments

The controller can further be adapted to determine a point in time at which the driver imprints/transmits in/to the operating element the request to change a lane currently being driven on and, after the passing of a period of time since the determined point in time, to effect/cause the indication of the lane changing request by the direction indicator to be terminated.

In a variant, the determination of the point in time and the passing of the period of time can be implemented jointly by a delay device.

An advantage here is that the indication by the direction indicator is terminated after a period of time independently of the environmental sensors and thus does not continue indefinitely even in the case of a malfunction of the environmental sensors, for example due to unfavorable environmental conditions or technical defects.

The period of time can be, for example, a predetermined period of time, in particular a predetermined period of time having a duration of up to 20 seconds.

In an alternative variant, the controller is adapted to determine a number of individually emitted direction indication signals, for example blinking signals, and to effect/cause the indication of the lane changing request by the direction indicator to be terminated after a predetermined number of individual direction indication signals have been emitted.

The predetermined number of individual direction indication signals can be, for example, a predetermined number of up to 10 individually emitted direction indication signals, in particular 10 blinking signals.

In a variant of the control system, a speed sensor can further be provided and can be adapted to detect a current movement speed of the motor vehicle. In this variant, the controller is further adapted to determine the movement speed of the motor vehicle at the point in time at which the lane changing request is imprinted/transmitted in/to the operating element and to determine the period of time after which the termination of the indication of the lane changing request is to be effected/caused, depending on the movement speed of the motor vehicle at the point in time at which the lane changing request is imprinted/transmitted in/to the operating element.

In other words, in this variant the controller determines the period of time after which the indication of the lane changing request is terminated at the latest, depending on the speed of the vehicle at the point in time at which the lane changing request is imprinted/transmitted.

An advantage here is that an expected maximum duration of a lane change in dependence on a relevant parameter can be determined and thus in particular a disproportionately long indication of a lane changing request at low vehicle speeds can be avoided in the event of an environmental sensor malfunction. In other embodiments, further parameters of the moving motor vehicle, for example an acceleration or a distance from a vehicle ahead, can be determined alternatively or in addition by the controller using the environmental sensors. The controller is thereby able to determine the period of time after which the indication of the lane changing request is terminated at the latest, in dependence on the speed and/or the further parameters.

In one embodiment, the controller can be adapted to calculate/determine/specify a period of time having a duration of 6 seconds when the movement speed of the motor vehicle at the point in time at which the lane changing request is imprinted/transmitted in/to the operating element by the driver is less than 150 kilometers per hour, and to calculate/determine/specify a period of time having a duration of up to 20 seconds when the movement speed of the motor vehicle at the point in time at which the lane changing request is imprinted/transmitted in/to the operating element by the driver is at least 150 kilometers per hour.

In an alternative variant, the controller is adapted to determine a number of individual emitted direction indication signals, for example blinking signals, and to effect/cause the indication of the lane changing request by the direction indicator to be terminated after a number of individual direction indication signals determined in dependence on the vehicle speed has been emitted. In this alternative variant, the controller is adapted to determine the movement speed of the motor vehicle at the point in time at which the lane changing request is imprinted/transmitted in/to the operating element by the driver and to determine the number of individual emitted direction indication signals after the emission of which the termination of the indication of the lane changing request is to be effected/caused, depending on the movement speed of the motor vehicle at the point in time at which the lane changing request is imprinted/transmitted in/to the operating element by the driver.

A control method for a direction indicator of a motor vehicle comprises the steps:

imprinting/transmitting a lane changing request in/to an actuatable operating element by the driver of the motor vehicle;

indicating the lane changing request by the direction indicator;

determining a position of the motor vehicle on a lane of a road currently being driven on;

terminating the indication of the lane changing request by the direction indicator depending on the determined position of the motor vehicle.

A control method can further comprise at least one of the following steps:

determining a point in time at which the driver imprints/transmits the lane changing request for changing a lane currently being driven on in/to the operating element;

terminating the indication of the lane changing request by the direction indicator after a period of time since the determined point in time has passed;

determining a current movement speed of the motor vehicle at the point in time at which the lane changing request is imprinted/transmitted in/to the operating element by the driver;

determining the period of time depending on the movement speed of the motor vehicle at the point in time at which the lane changing request is imprinted/transmitted in/to the operating element by the driver;

terminating the indication of the lane changing request by the direction indicator after a period of time of 6 seconds has passed when the movement speed of the motor vehicle at the point in time at which the lane changing request is imprinted/transmitted in/to the operating element by the driver is less than 150 kilometers per hour;

terminating the indication of the lane changing request by the direction indicator after a period of time of 20 seconds has passed when the movement speed of the motor vehicle at the point in time at which the lane changing request is imprinted/transmitted in/to the operating element by the driver is at least 150 kilometers per hour;

terminating the indication of the lane changing request by the direction indicator after a period of time of 20 seconds has passed.

The sequence of the steps is not fixed.

### BRIEF DESCRIPTION OF THE DRAWING

Further objects, features, advantages and possible applications will become apparent from the following description of exemplary embodiments, which are not to be interpreted as being limiting, with reference to the accompanying drawings. In the drawings, all the features which are described and/or depicted show the subject-matter disclosed herein on their own or in any desired combination, also independently of their grouping in the claims or their references. The dimensions and proportions of the components shown in the figures are not necessarily to scale; they can differ from those shown in embodiments for implementation.

FIG. 1 A-FIG. 1 C show, schematically and by way of example, the sequence of a lane change of a motor vehicle on a multi-lane carriageway.

FIG. 2 shows, schematically and by way of example, a control system for a direction indicator of a motor vehicle.

### DETAILED DESCRIPTION OF THE DRAWINGS

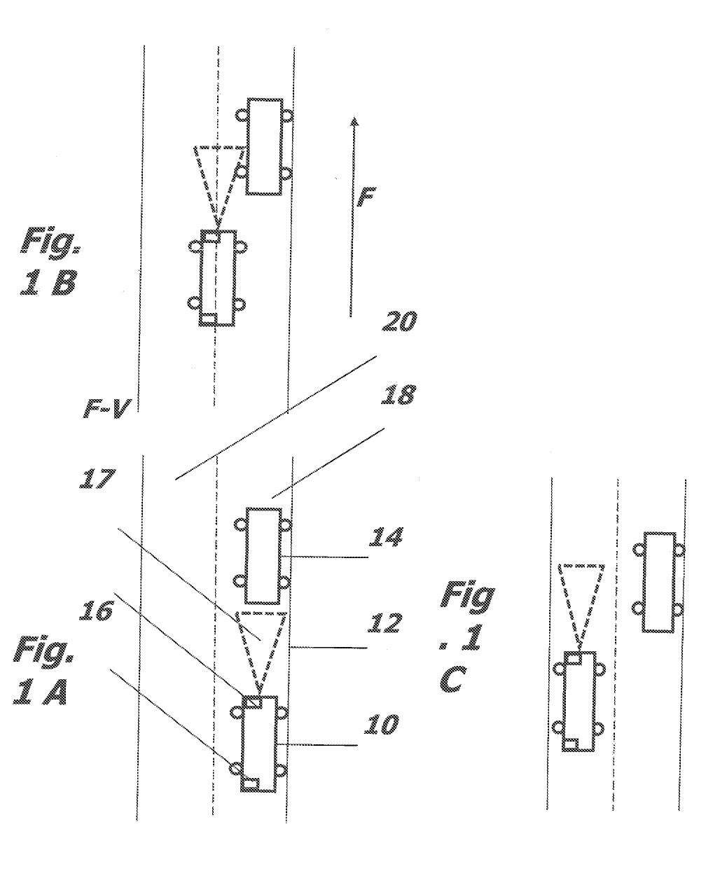

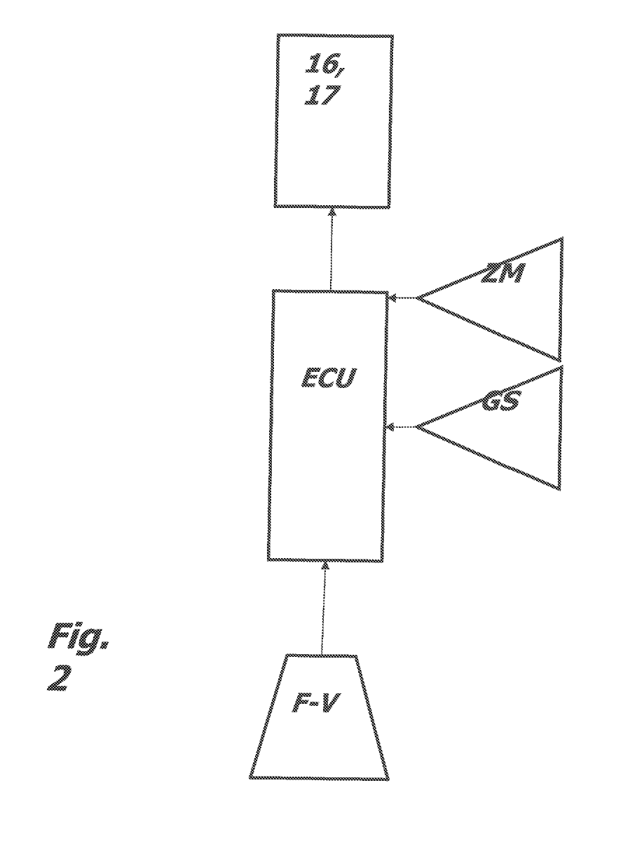

FIG. 1A shows, schematically, a driving situation in which an own vehicle 10 is driving on a straight two-lane section of road 12. A control system associated with the vehicle and shown schematically in FIG. 2 serves for controlling four direction indicators of the motor vehicle 10. The motor vehicle 10 has one direction indicator at the front on the left in the corner region of the vehicle, one at the front on the right in the corner region of the vehicle, one at the back on the left in the corner region of the vehicle and one at the back on the right in the corner region of the vehicle. For the sake of clarity, however, only the direction indicators 16, 17 arranged on the left of the vehicle in the direction of travel are shown in the figures. The first direction indicator 16 is arranged at the back on the left in the corner region of the vehicle, while the second direction indicator 17 is arranged at the front on the left in the corner region of the vehicle.

The motor vehicle 10 is moving in a direction of travel F in a first lane 18 of the section of road 12. In order to overtake a further vehicle 14 travelling in front of the motor vehicle 10, the driver of the motor vehicle 10 intends to leave the first lane 18 and continue moving in the direction of travel F in a second lane 20.

In order to indicate the intention to change lanes to a driver of the further vehicle 14 by means of the direction indicators 16, 17, the driver of the motor vehicle 10 actuates an operating element BE, for example a switch lever. The operating element BE is adapted to transmit a control signal to a controller ECU, which thereupon causes the lane change intention to be indicated by the direction indicators 16, 17.

The controller ECU accesses environmental sensors of the own vehicle. The environmental sensors comprise a (infrared and daylight) (video) camera F-V (not shown in greater detail), the detection range of which is shown schematically in the figures and by means of which a position of the motor vehicle 10 in a lane can be detected and provided. The control system ECU comprises a computer, program/data storage means, input/output devices, etc. (not shown in greater detail).

The control system shown in FIG. 2 further comprises a steering wheel sensor LS, which is suitable for detecting in particular a steering movement of the driver, a speed sensor GS, which is suitable for detecting in particular a current speed of the moving motor vehicle 10, and a timekeeper ZM which is suitable for determining/storing in particular a point in time and/or for performing a time measurement.

The controller ECU is configured to access detected and/or stored data/physical parameters/positions/acquisitions of the steering wheel sensor LS, the speed sensor GS and the timekeeper ZM and/or to store them.

The controller ECU is adapted to determine, by means of the timekeeper ZM, the point in time at which the operating element BE is actuated by the driver of the motor vehicle 10.

The controller ECU is further adapted to terminate the indication of the lane changing request by the direction indicators 16, 17 on the basis of a further actuation of the operating element BE by the driver of the motor vehicle 10 and/or after a period of time has passed. The passing of the period of time is determined by the controller ECU by means of the timekeeper ZM.

The duration of the period of time is determined by the controller ECU by means of the speed sensor GS. If the motor vehicle 10 is moving at a speed of at least 150 kilometers per hour, a duration of 20 seconds is specified by the controller ECU for the period of time. If the vehicle is moving at a speed of less than 150 kilometers per hour, a duration of 6 seconds is specified by the controller ECU for the period of time.

If the driver of the motor vehicle 10 performs a steering movement, the steering wheel sensor LS transmits a corresponding signal to the controller ECU. The controller ECU is adapted to determine, by means of the timekeeper ZM, the point in time at which the steering movement is performed by the driver of the motor vehicle 10.

The controller ECU is further adapted to determine by means of the camera F-V a position of the vehicle 10 in a lane 18, 20 as soon as both a control signal of the operating element BE, which indicates the driver's lane changing request, and a signal of the steering wheel sensor LS, which indicates a steering movement of the driver, have been transmitted to the controller ECU. In a further development, the controller determines the position of the vehicle 10 in a lane 18, 20 only after a buffer time of, for example, 2 seconds, in order to ensure that the vehicle has at least partially left the first lane 18 as a result of the steering movement of the driver, so that the motor vehicle 10 is no longer wholly situated in the lane 18.

In other words, the controller ECU determines the position of the motor vehicle 10 relative to a lane after two requirements have been met—(i) actuation of the operating element BE and (ii) detection of a steering movement.

If the controller ECU determines, by means of the camera F-V, that the motor vehicle 10 is not (or at least not yet) wholly situated in a lane 18, 20, as is shown in FIG. 1 B, then the driver's lane changing request continues to be indicated by the direction indicator 16, 17 until the period of time determined by means of the speed sensor GS has elapsed or the driver of the motor vehicle 10 actuates the operating element BE again.

The controller ECU is further adapted to repeatedly determine the position of the motor vehicle 10 in a lane 18, 20 by means of the camera F-V following the initial determination, until the indication of the lane changing request by the direction indicators 16, 17 is terminated. For example, the controller ECU can determine the position of the motor vehicle 10 in a lane 18, 20 at a regular time interval, in particular at a time interval having a duration of one second.

If the controller ECU determines, by means of the camera F-V, that the motor vehicle 10 is situated wholly in a lane 18, 20, as is shown in FIG. 1 C, then the indication of the driver's lane changing request by the direction indicators 16, 17 is terminated, irrespective of whether the period of time determined by means of the speed sensor GS has elapsed or the driver actuates the operating element BE again.

If the vehicle 10 is situated wholly in a lane, then the controller ECU defines the intended lane change as wholly complete or wholly aborted. An advantage here is that, by a single actuation of the operating element BE, the driver's lane changing request is indicated for a period of time which is appropriate to the speed and traffic situation. In particular, the lane changing request is signaled by the direction indicators 16, 17 to the driver of the further vehicle 14, who notices the initiated lane changing maneuver only while it is being performed (FIG. 1B), even in the case of longer overtaking maneuvers at higher speeds (e.g. on a freeway). Furthermore, the indication by the direction indicators 16, 17 is terminated automatically once the lane changing maneuver has been completed or aborted, and misleading signal transmissions are thus prevented.

The person skilled in the art will appreciate that the control system disclosed herein can likewise be used in traffic situations which involve one or more lane changes, for example in an overtaking maneuver.

The above-described variants and the structural and operational aspects thereof serve merely for better understanding of the structure, functioning and properties; they do not limit the disclosure, for example, to the exemplary embodiments. The figures are schematic, important properties and effects in some cases being shown on a significantly enlarged scale in order to clarify the functions, active principles, technical configurations and features. Any mode of functioning, any principle, any technical configuration and any feature that is/are disclosed in the figures or in the text can be combined freely and arbitrarily with all the claims, any feature in the text and in the other figures, other modes of functioning, principles, technical configurations and features which are contained in this disclosure or follow therefrom, so that all conceivable combinations are to be assigned to the described variants. Combinations between all the individual implementations in the text, that is to say in every section of the description, in the claims, and also combinations between different variants in the text, in the claims and in the figures, are also included. The claims also do not limit the disclosure and thus the possible combinations of all the indicated features with one another. All the disclosed features are explicitly also disclosed herein individually and in combination with all the other features.

The disclosed numerical values for periods of time, buffer times, numbers of repetitions, durations, speeds, numbers of direction indicators, etc. are merely exemplary in nature and do not limit the subject-matter according to the invention thereto. An implementation of periods of time, buffer times, numbers of repetitions, durations, speeds, numbers of direction indicators, etc. that differs from the disclosed numerical values is expressly possible.

1. A control system for a direction indicator of a motor vehicle, based on environmental sensors of the motor vehicle, wherein the environmental sensors are adapted to detect the position of the motor vehicle on a lane of a road currently being driven on;
an operating element which may be operated by a driver of the motor vehicle is provided and adapted to be imprinted with a lane changing request by the driver for changing a lane currently being driven on;
a direction indicator is provided and adapted to indicate the driver's lane changing request;
a controller is provided and is adapted to:
cause an indication of a lane changing request imprinted in the operating element by the direction indicator;
repeatedly detect the position of the motor vehicle on a lane of the road currently being driven on by means of the environmental sensors;
cause the termination of the indication of the lane changing request by the direction indicator depending on the determination of the position of the motor vehicle on a lane of the road currently being driven on.

2. The control system as claimed in claim 1, wherein the controller is further adapted to:
determine a point in time at which the driver imprints in the operating element the lane changing request for changing a lane currently being driven in;
to effect the termination of the indication of the lane changing request by the direction indicator when a period of time since the determined point in time has passed.

3. The control system as claimed in claim 2, wherein the period of time is a predetermined period of time, in particular a period of time having a duration of 20 seconds.

4. The control system as claimed in claim 2, wherein a speed sensor is provided and is adapted to detect a current movement speed of the motor vehicle;
the controller is further adapted to:
determine the movement speed of the motor vehicle at the point in time at which the lane changing request is imprinted in the operating element by the driver;
to determine the period of time after the passing of which a termination of the indication of the lane changing request is to be effected, depending on the movement speed of the motor vehicle at the point in time at which the lane changing request is imprinted in the operating element by the driver.

5. The control system as claimed in claim 4, wherein the controller is further adapted to:
determine a period of time having a duration of 6 seconds when the movement speed of the motor vehicle at the point in time at which the lane changing request is imprinted in the operating element by the driver is less than 150 kilometers per hour;
determine a period of time having a duration of 20 seconds when the movement speed of the motor vehicle at the point in time at which the lane changing request is imprinted in the operating element by the driver is at least 150 kilometers per hour;

6. A control method for a direction indicator of a motor vehicle, comprising the steps:
imprinting a lane changing request in an actuatable operating element by the driver of the motor vehicle;
indicating the lane changing request by the direction indicator;
determining a position of the motor vehicle on a lane of a road currently being driven on;
terminating the indication of the lane changing request by the direction indicator depending on the determined position of the motor vehicle.

7. The method as claimed in claim 6, further comprising at least one of the steps:
determining a point in time at which the driver imprints the lane changing request for changing a lane currently being driven on in the operating element;
terminating the indication of the lane changing request by the direction indicator after a period of time since the determined point in time has passed.

8. The method as claimed in claim 7, further comprising at least one of the steps:
determining a current movement speed of the motor vehicle at the point in time at which the lane changing request is imprinted in the operating element by the driver;
determining the period of time depending on the movement speed of the motor vehicle at the point in time at which the lane changing request is imprinted in the operating element by the driver.

9. The method as claimed in claim 7, further comprising at least one of the steps:
terminating the indication of the lane changing request by the direction indicator after a period of time of 6 seconds has passed when the movement speed of the motor vehicle at the point in time at which the lane changing request is imprinted in the operating element by the driver is less than 150 kilometers per hour;
terminating the indication of the lane changing request by the direction indicator after a period of time of 20 seconds has passed when the movement speed of the motor vehicle at the point in time at which the lane changing request is imprinted in the operating element by the driver is at least 150 kilometers per hour; or
terminating the indication of the lane changing request by the direction indicator after a period of time of 20 seconds has passed.
